(19) United States
(12) Patent Application Publication
(10) Pub. No.: US 2018/0290426 A1
(43) Pub. Date: Oct. 11, 2018

(54) 0 DEGREE UNIDIRECTIONAL YARN PREPREG, METHOD FOR PRODUCING SAME, AND METHOD FOR PRODUCING MULTIAXIAL PREPREG COMPOSITE MATERIAL USING SAME

(71) Applicant: KOLON INDUSTRIES, INC., Gwacheon-si, Gyeonggi-do (KR)

(72) Inventors: Joon Young YOON, Yongin-si (KR); Hyun Chul LEE, Yongin-si (KR); Eun Jeong CHO, Yongin-si (KR)

(73) Assignee: KOLON INDUSTRIES, INC., Gwacheon-si, Gyeonggi-do (KR)

(21) Appl. No.: 15/578,008

(22) PCT Filed: May 13, 2016
(86) PCT No.: PCT/KR2016/005059

§ 371 Date: Nov. 29, 2017

(30) Foreign Application Priority Data
Jun. 1, 2015 (KR) 10-2015-0077258

(51) Int. Cl. B32B 5/12; C08J 5/24; D03D 15/00; D03D 15/08; B32B 37/20; B32B 7/12; B32B 5/26; B32B 5/02; D03D 15/06; B32B 37/04; B32B 37/10; B29C 70/20; B29C 70/50

(52) U.S. Cl. CPC B32B 5/12; B29K 2307/04; D03D 15/0088; D03D 15/08; B32B 37/20; B32B 7/12; B32B 5/26; B32B 5/024; D03D 15/06; B32B 37/04; B32B 37/10; B29C 70/202; B29C 70/50; C08J 2377/10; C08J 2423/12; D10B 2331/021; D10B 2101/12; D10B 2321/022; B32B 2250/20; B32B 2260/023; B32B 2260/046; B32B 2305/188; B32B 2305/076; B32B 2323/10; B32B 2377/00; B29K 2313/00; C08J 5/24

(57) ABSTRACT

A 0° unidirectional yarn prepreg and a preparation method are disclosed. The 0° unidirectional yarn prepreg has high-strength filaments which are arranged in parallel to each other in an axial direction X of a winding roller around which unidirectional yarn prepregs are wound and a resin is impregnated. The method includes steps of: (i) weaving a fabric using a thermoplastic film tape as a warp and using high-strength filaments as wefts; and (ii) performing thermal compression on the woven fabric at a temperature in which the warp is melted. Also, a multiaxial prepreg composite material is prepared by simultaneously and continuously supplying the 0° unidirectional yarn prepreg A prepared as described above method and a 90° unidirectional yarn prepreg B prepared by a conventional warping method to a thermal compression roller, and performing thermal compression thereon.

### TECHNICAL FIELD

The present invention relates to a 0° unidirectional yarn prepreg, a method for producing the same, and a method for producing a multiaxial prepreg composite material using the same.

More specifically, the present invention relates to a unidirectional yarn prepreg in which high-strength filaments are arranged in parallel to each other in an axial direction X of a winding roller around which unidirectional yarn prepregs are wound and a resin is impregnated (hereinafter referred to as a “0° unidirectional yarn prepreg”), and a method for continuously preparing the same.

Further, the present invention relates to a method for producing a composite material in which two unidirectional yarn prepregs having different arrangement directions of high-strength filaments from each other are laminated (hereinafter referred to as a “multiaxial prepreg composite material), which includes the steps of: simultaneously and continuously supplying (i) the 0° unidirectional yarn prepreg prepared as described above, and (ii) a unidirectional yarn prepreg prepared by a conventional warping method, in which high-strength filaments are arranged in parallel to each other in a direction Y perpendicular to an axial direction X of a winding roller around which unidirectional yarn prepregs are wound and a resin is impregnated (hereinafter referred to as a “90° unidirectional yarn prepreg”) to a thermal compression roller; and performing thermal compression thereon.

### BACKGROUND ART

As a conventional method for preparing a unidirectional yarn prepreg in which high-strength filaments are arranged in one direction and a resin is impregnated, a method, in which high-strength filaments are arranged in parallel to each other in a winding direction using a warping machine, and a resin is impregnated therein, followed by wining on a winding roller 1, has been used in the art.

However, the above-described conventional method has a problem that only a 90° unidirectional yarn prepreg B, in which high-strength filaments are arranged in parallel to each other in a direction Y perpendicular to an axial direction X of a winding roller around which unidirectional yarn prepregs are wound as illustrated in FIG. 1, can be continuously prepared in a roll form, whereas a 0° unidirectional yarn prepreg A, in which high-strength filaments are arranged in parallel to each other in the axial direction X of the winding roller around which the unidirectional yarn prepregs are wound as illustrated in FIG. 2, cannot be continuously prepared in a roll form.

Meanwhile, there is also a problem in the art that, in order to produce a multiaxial prepreg composite material C by using only the 90° unidirectional yarn prepreg B prepared by the conventional method, in which (i) two or more unidirectional yarn prepregs are laminated, and (ii) one unidirectional yarn prepreg of two unidirectional yarn prepregs laminated adjacent to each other includes high-strength filaments whose orientation direction forms an inclination angle of 90° with respect to the orientation direction of the high-strength filaments included in the other unidirectional yarn prepreg, a cut part of the 90° unidirectional yarn prepreg B, which is cut in the same length as a width of the 90° unidirectional yarn prepreg B in a length direction of the 90° unidirectional yarn prepreg B, should be laminated on the 90° unidirectional yarn prepreg B illustrated in FIG. 1 by rotating it 90 degrees, and then should be perform thermal compression thereon, such that a process of producing the multiaxial prepreg composite material C is complicated, and the multiaxial prepreg composite material C could not be produced by a continuous process.

### DISCLOSURE

### Technical Problem

It is an object of the present invention to provide a 0° unidirectional yarn prepreg in which high-strength filaments are arranged in parallel to each other in an axial direction X of a winding roller around which unidirectional yarn prepregs are wound and a resin is impregnated, and a method capable of continuously preparing the same in a roll form by a simple process.

Another object of the present invention is to provide a method capable of continuously producing a multiaxial prepreg composite material C in which the 0° unidirectional yarn prepreg A and a 90° unidirectional yarn prepreg B are laminated in a roll form.

### Technical Solution

In order to achieve the above objects, the present invention prepares a 0° unidirectional yarn prepreg, in which high-strength filaments are arranged in parallel to each other in an axial direction X of a winding roller around which unidirectional yarn prepregs are wound and a resin is impregnated, by using the steps of: (i) weaving a fabric using a thermoplastic film tape having a width of 5 to 60 mm as a warp and using high-strength filaments as wefts; and (ii) performing thermal compression on the woven fabric at a temperature in which the warp is melted.

Meanwhile, the present invention produces a multiaxial prepreg composite material having a structure in which (i) two or more unidirectional yarn prepregs are laminated, and (ii) one unidirectional yarn prepreg of two unidirectional yarn prepregs laminated adjacent to each other includes high-strength filaments whose orientation direction forms an inclination angle of 90° with respect to the orientation direction of the high-strength filaments included in the other unidirectional yarn prepreg, by using the steps of: simultaneously and continuously supplying the 0° unidirectional yarn prepreg A prepared as described above and a 90° unidirectional yarn prepreg B prepared by the conventional warping method to a thermal compression roller 2, and performing thermal compression thereon.

### Advantageous Effects

According to the present invention, a 0° unidirectional yarn prepreg, in which high-strength filaments are arranged in parallel to each other in an axial direction X of the winding roller around which unidirectional yarn prepregs are wound and a resin is impregnated, may be continuously prepared in a roll form.

According to the present invention, it is possible to continuously produce a multiaxial prepreg composite material C in which (i) two or more unidirectional yarn prepregs are laminated, and (ii) one unidirectional yarn prepreg of two unidirectional yarn prepregs laminated adjacent to each other includes high-strength filaments whose orientation direction forms an inclination angle of 90° with respect to the orientation direction of the high-strength filaments included in the other unidirectional yarn prepreg through a simpler process, thereby improving productivity and reducing manufacturing costs.

### DESCRIPTION OF DRAWINGS

FIG. 1 is a schematic view illustrating a state in which a 90° unidirectional yarn prepreg B prepared by a conventional method is unwound from a winding roller 1.

FIG. 2 is a schematic view illustrating a state in which a 0° unidirectional yarn prepreg A prepared by the present invention is unwound from the winding roller 1.

FIG. 3 is a schematic view of a process for producing a multiaxial prepreg composite material C.

### BEST MODE

Hereinafter, the present invention will be described in detail with reference to the accompanying drawings.

The present invention prepares a 0° unidirectional yarn prepreg A, in which high-strength filaments are arranged in parallel to each other in an axial direction X of a winding roller around which unidirectional yarn prepregs are wound and a resin is impregnated, by using the steps of: (i) weaving a fabric using a thermoplastic film tape having a width of 5 to 60 mm as a warp and using high-strength filaments as wefts; and (ii) performing thermal compression on the woven fabric at a temperature in which the warp is melted.

The high-strength filament may be aramid filaments, carbon fiber filaments, or the like, and when weaving the fabric, the aramid filaments or the carbon fiber filaments may be used alone, or in a form in which the high-strength filaments different from each other are alternately arranged.

As the thermoplastic film tape, a polypropylene film tape, a polyethylene film tape, a polyimide film tape, a polyester film tape, a polyether ether ketone (PEEK) film tape, a polyurethane film tape, or the like is used. In the present invention, the thermoplastic film tape is not particularly limited in terms of a type.

The 0° unidirectional yarn prepreg prepared according to the present invention is free from the problem that a strength of the prepreg is weakened since there is no intersection of the warp and the wefts in comparison with the conventional prepreg.

According to the present invention, it is possible to continuously prepare the 0° unidirectional yarn prepreg A in a roll form, which cannot be prepared by a continuous process in the conventional method.

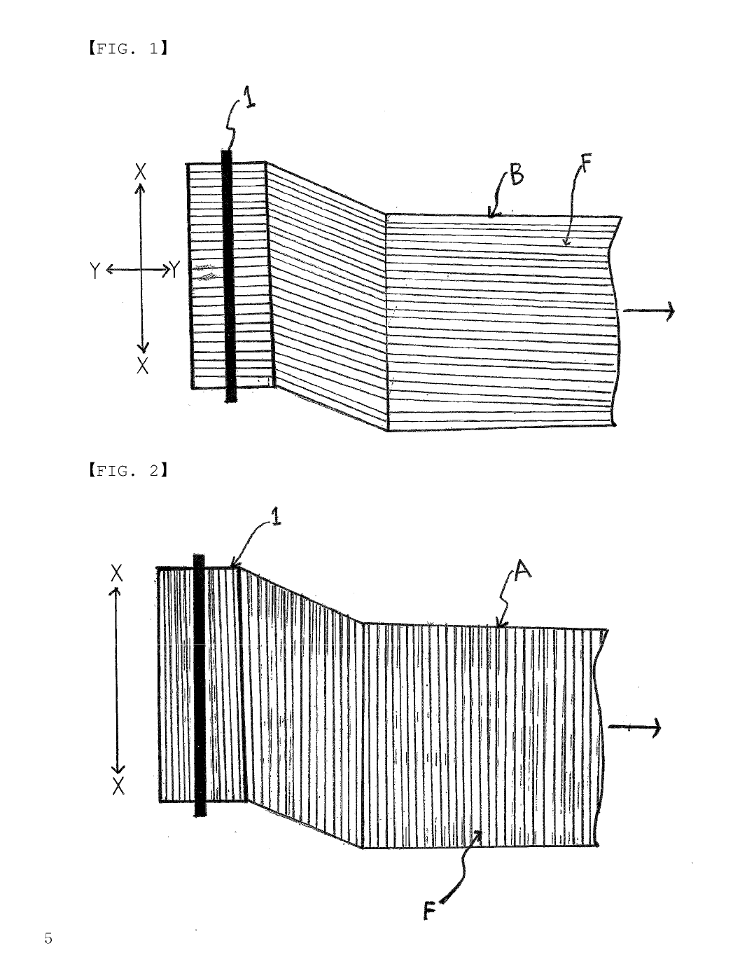

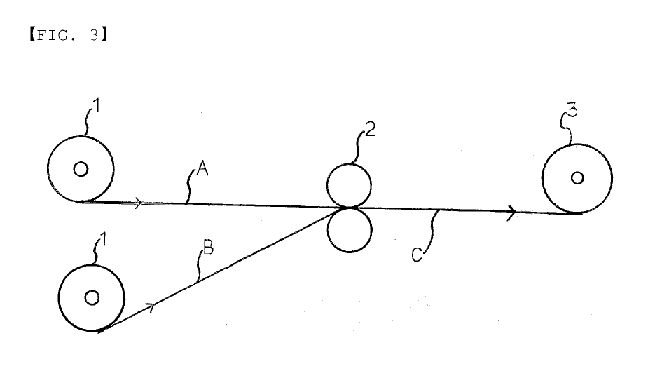

Meanwhile, in the present invention, the 0° unidirectional yarn prepreg A of FIG. 2 which is prepared as described above; and the 90° unidirectional yarn prepreg B of FIG. 1 which is prepared by the conventional warping method are simultaneously and continuously supplied to a thermal compression roller 2 as illustrated in FIG. 3, then thermal compression was performed thereon, to produce the multiaxial prepreg composite material C.

The multiaxial prepreg composite material C has a structure in which (i) two or more unidirectional yarn prepregs are laminated, and (ii) one unidirectional yarn prepreg of two unidirectional yarn prepregs laminated adjacent to each other includes high-strength filaments whose orientation direction forms an inclination angle of 90° with respect to the orientation direction of the high-strength filaments included in the other unidirectional yarn prepreg.

According to the present invention, it is possible to continuously produce the multiaxial prepreg composite material C in a roll form through a simpler process.

Hereinafter, the present invention will be described in more detail with reference to examples and a comparative example.

The following examples are proposed as preferred embodiments of the present invention, and it is duly not construed that the scope of the present invention is particularly limited to these examples.

### EXAMPLE 1

A fabric having a plain-woven texture was woven using a polypropylene film tape having a density of 0.9 as a warp and using aramid filaments as wefts, then the woven fabric was subjected to thermal compression at 140° C. to melt the polypropylene film tape, thereby, as illustrated in FIG. 2, a 0° unidirectional yarn prepreg A, in which the aramid filaments are arranged in parallel to each other in an axial direction X of a winding roller, was prepared in a roll form.

Next, the 0° unidirectional yarn prepreg A prepared as described above and the 90° unidirectional yarn prepreg B prepared by a conventional warping method in such a way the aramid filaments are arranged in parallel to each other in a direction Y perpendicular to the axial direction X of the winding roller were simultaneously and continuously supplied to a thermal compression roller 2 as illustrated in FIG. 3, then thermal compression was performed thereon, to continuously produce a multiaxial prepreg composite material C in a roll form.

### EXAMPLE 2

A fabric having a plain-woven texture was woven using a polypropylene film tape as a warp and using carbon fiber filaments as wefts, then the woven fabric was subjected to thermal compression at 200° C. to melt the polypropylene film tape, thereby, as illustrated in FIG. 2, a 0° unidirectional yarn prepreg A, in which the carbon fiber filaments are arranged in parallel to each other in an axial direction X of a winding roller, was prepared in a roll form.

Next, the 0° unidirectional yarn prepreg A prepared as described above and the 90° unidirectional yarn prepreg B prepared by a conventional warping method in such a way the carbon fiber filaments are arranged in parallel to each other in a direction Y perpendicular to the axial direction X of the winding roller were simultaneously and continuously supplied to a thermal compression roller 2 as illustrated in FIG. 3, then thermal compression was performed thereon, to continuously produce a multiaxial prepreg composite material C in a roll form.

### EXAMPLE 3

A fabric having a plain-woven texture was woven using a polypropylene film tape as a warp and using aramid filaments and carbon fiber filaments in a ratio of 2:2 as wefts, then the woven fabric was subjected to thermal compression at 140° C. to melt the polypropylene film tape, thereby, as illustrated in FIG. 2, a 0° unidirectional yarn prepreg A, in which the wefts are arranged in parallel to each other in an axial direction X of a winding roller, was prepared in a roll form.

Next, the 0° unidirectional yarn prepreg A prepared as described above and the 90° unidirectional yarn prepreg B prepared by a conventional warping method in such a way the aramid filaments and carbon fiber filaments are arranged in parallel to each other in a direction Y perpendicular to the axial direction X of the winding roller were simultaneously and continuously supplied to a thermal compression roller 2 as illustrated in FIG. 3, then thermal compression was performed thereon, to continuously produce a multiaxial prepreg composite material C in a roll form.

### COMPARATIVE EXAMPLE 1

As illustrated in FIG. 1, a 90° unidirectional yarn prepreg B, in which aramid filaments are arranged in parallel to each other in a direction Y perpendicular to an axial direction X of a winding roller, was continuously prepared in a roll form by a conventional warping method.

Next, the 90° unidirectional yarn prepreg B was cut in the same length as a width of the 90° unidirectional yarn prepreg B, and the cut part was rotated 90 degrees, then the cut part was laminated on another 90° unidirectional yarn prepreg B, followed by performing thermal compression thereon, to continuously produce a multiaxial prepreg composite material C in a roll form.

In Examples 1 to 3, the 0° unidirectional yarn prepreg A was continuously prepared in a roll form, then was continuously laminated with the 90° unidirectional yarn prepreg B prepared by the conventional warping method in a roll form, followed by performing thermal compression thereon, such that the multiaxial prepreg composite material C could be continuously produced, but in Comparative Example 1, the above-described continuous production process was impossible.

### DESCRIPTION OF REFERENCE NUMERALS

1: Winding roller with unidirectional yarn prepreg wound thereon

A: 0° unidirectional yarn prepreg

B: 90° unidirectional yarn prepreg

X: Axial direction of winding roller 1

Y: Direction perpendicular to axial direction of winding roller 1

2: Thermal compression roller

C: Multiaxial prepreg composite material

3: Winding roller for multiaxial prepreg composite material

F: High-strength filament

### INDUSTRIAL APPLICABILITY

The 0° unidirectional yarn prepreg according to the present invention may be used as a material for producing a multiaxial prepreg composite material, a material for manufacturing a helmet, a material for manufacturing a golf shaft, a material for manufacturing an impact beam for an automobile door and the like.

The multiaxial prepreg composite material according to the present invention may be used as a material for manufacturing a helmet, a material for manufacturing a golf shaft, a material for manufacturing an impact beam for an automobile door and the like.

1. A 0° unidirectional yarn prepreg characterized in that high-strength filaments are arranged in parallel to each other in an axial direction X of a winding roller around which unidirectional yarn prepregs are wound and a resin is impregnated.

2. The 0° unidirectional yarn prepreg according to claim 1, wherein the high-strength filament is one selected from a group consisting of aramid filaments and carbon fiber filaments.

3. A method for producing a 0° unidirectional yarn prepreg, in which high-strength filaments are arranged in parallel to each other in an axial direction X of a winding roller around which unidirectional yarn prepregs are wound and a resin is impregnated, the method comprising the steps of:
(i) weaving a fabric using a thermoplastic film tape having a width of 5 to 60 mm as a warp and using high-strength filaments as wefts; and
(ii) performing thermal compression on the woven fabric at a temperature in which the warp is melted.

4. The method according to claim 3, wherein the high-strength filament is one selected from a group consisting of aramid filaments and carbon fiber filaments.

5. The method according to claim 3, wherein the wefts included in the fabric have a form in which the high-strength filaments different from each other are alternately arranged.

6. The method according to claim 3, wherein the thermoplastic film tape is one selected from a group consisting of a polypropylene film tape, a polyethylene film tape, a polyimide film tape, a polyester film tape, a polyether ether ketone (PEEK) film tape and a polyurethane film tape.

7. A method for producing a multiaxial prepreg composite material having a structure, in which (i) two or more unidirectional yarn prepregs are laminated, and (ii) one unidirectional yarn prepreg of two unidirectional yarn prepregs laminated adjacent to each other includes high-strength filaments whose orientation direction forms an inclination angle of 90° with respect to the orientation direction of the high-strength filaments included in the other unidirectional yarn prepreg, the method comprising the steps of:
simultaneously and continuously supplying a 0° unidirectional yarn prepreg A in which high-strength filaments F are arranged in parallel to each other in an axial direction X of a winding roller around which unidirectional yarn prepregs are wound and a resin is impregnated; and a 90° unidirectional yarn prepreg B in which high-strength filaments F are arranged in parallel to each other in a direction Y perpendicular to the axial direction X of the winding roller around which the unidirectional yarn prepregs are wound to a thermal compression roller 2; and
performing thermal compression thereon.

8. The method according to claim 7, wherein the 0° unidirectional yarn prepreg A is prepared by the steps of: (i) weaving a fabric using a thermoplastic film tape having a width of 5 to 60 mm as a warp and using high-strength filaments as wefts; and (ii) performing thermal compression on the woven fabric at a temperature in which the warp is melted

9. The method according to claim 7, wherein the 90° unidirectional yarn prepreg B is prepared by a warping method using a warping machine.
